(19) United States
(12) Patent Application Publication
(10) Pub. No.: US 2026/0312626 A1
(43) Pub. Date: Oct. 8, 2026

(54) MULTI-ANTENNA SYSTEM FOR NON-TERRESTRIAL COMMUNICATIONS

(71) Applicant: Astranis Space Technologies Corp, San Francisco, CA (US)

(72) Inventors: Steven Richard Joseph, San Francisco, CA (US); Riley Nelson Pack, Arvada, CO (US); Andrew Philip Cragg, Boulder, CO (US); Andrew William Meyer, Fairfield, CA (US); Riccardo Dina, Sausalito, CA (US); Mason Robert Rawson, San Diego, CA (US); Adam Hunter Bily, Mukilteo, WA (US); Robert Conder Chiu, Santa Rosa, CA (US); Sean Christopher Ortiz, Indialantic, FL (US); Luca Revelli, Larkspur, CA (US); John William Gedmark, Redwood City, CA (US)

(21) Appl. No.: 19/479,006

(22) PCT Filed: Apr. 26, 2024
(86) PCT No.: PCT/US2024/026680

§ 371 Date: Oct. 27, 2025

Related U.S. Application Data
(60) Provisional application No. 63/462,009, filed on Apr. 26, 2023.

(51) Int. Cl. H04B 7/005; H04B 1/40; H04B 7/185; H04L 5/00; H04L 25/02

(52) U.S. Cl. CPC H04B 7/005; H04B 1/40; H04B 7/185; H04L 5/0048; H04L 25/0224

(57) ABSTRACT

Communication to and from a non-terrestrial station can be performed with a plurality of antenna elements in a ground station. Reception-side beamforming algorithms and components align the received signals from the non-terrestrial station to generate a downlink data stream. Transmission-side beamforming algorithms and components transmit out-of-phase signals to the non-terrestrial station in an amount that when the out-of-phase signals arrive at the non-terrestrial station, they combine constructively.

### CROSS-REFERENCE TO RELATED APPLICATIONS

This application claims the benefit of priority of the U.S. Provisional Application No. 63/462,009, filed on Apr. 26, 2023, titled “MULTI-ANTENNA SYSTEM FOR NON-TERRESTRIAL COMMUNICATIONS,” which is hereby incorporated in its entirety, and should be considered a part of this application.

### BACKGROUND

### Field

This invention relates generally to the field of wireless communication, and more particularly to the field of communication between a non-terrestrial station and a ground station.

### Description of the Related Art

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Non-terrestrial communication typically is performed via a single antenna transceiver transmitting and receiving radio waves to and from a non-terrestrial station. The antenna transceiver is typically implemented with a large dish antenna. Transportation, installation and deployment of large dish antennas in general can present a substantial barrier in providing non-terrestrial communication and network access via non-terrestrial communication. Consequently, there is a need for more cost-effective alternatives to the current implementation of non-terrestrial communication technology.

### SUMMARY

The appended claims may serve as a summary of this application. Further areas of applicability of the present disclosure will become apparent from the detailed description, the claims, and the drawings. The detailed description and specific examples are intended for illustration only and are not intended to limit the scope of the disclosure.

### BRIEF DESCRIPTION OF THE DRAWINGS

These drawings and the associated description herein are provided to illustrate specific embodiments of the invention and are not intended to be limiting.

FIG. 1A illustrates an example embodiment of a non-terrestrial communication system.

FIG. 1B illustrates a non-terrestrial communication system according to an embodiment.

FIG. 2 illustrates a block diagram of an example overview of some additional components in the gateway of the embodiment of FIG. 1B.

FIG. 3 illustrates a block diagram of an example of components used in the reception-side beamforming.

FIG. 4 illustrates a block diagram of another example of components used in reception-side beamforming.

FIG. 5 illustrates an example flowchart of a method of estimating channel parameters, such as gain, phase and/or fractional delays according to an embodiment.

FIG. 6 illustrates an example flowchart of a method of using the estimated gain, phase and/or fractional delays to equalize signals.

FIG. 7A illustrates a block diagram of an example of components used in transmission-side beamforming.

FIG. 7B illustrates a block diagram of another example of components used in transmission-side beamforming.

FIG. 8 illustrates a flowchart of an example transmission-side beamforming method.

FIG. 9 illustrates an environment within which some embodiments may operate.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements. Some of the embodiments or their aspects are illustrated in the drawings.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

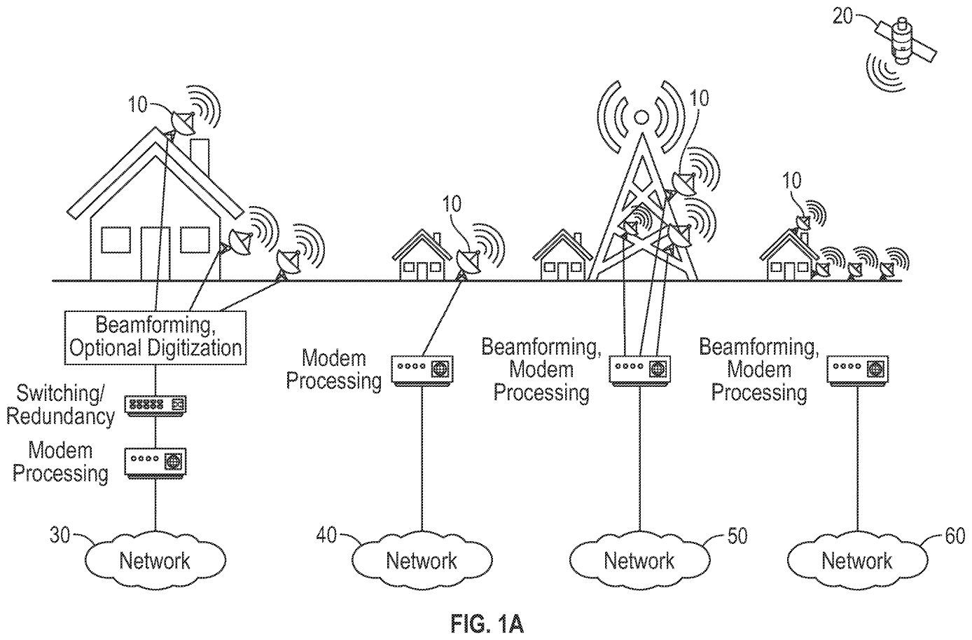

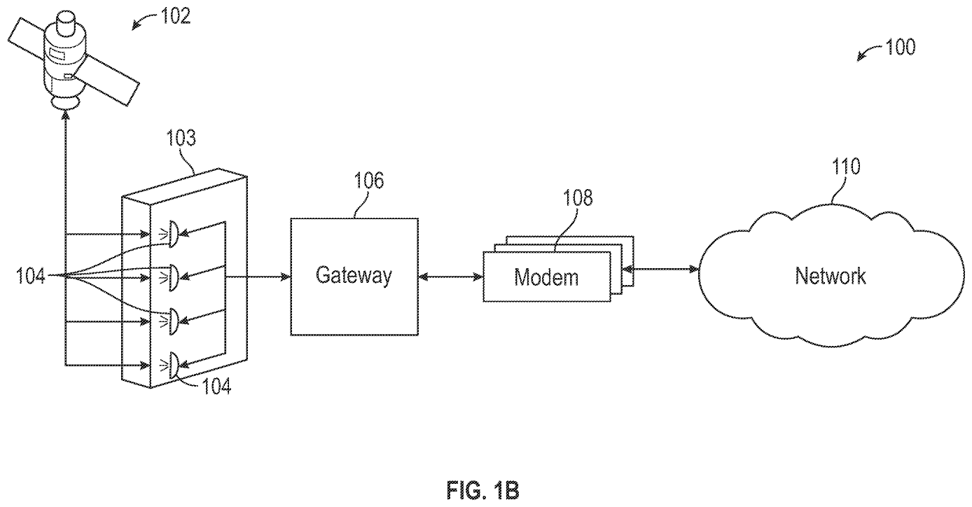

FIG. 1A illustrates an example of an embodiment of a non-terrestrial communication system. In this example, a gateway can use one or more antennas 10 to communicate with a non-terrestrial station 20. The gateway antennas 10 can be mounted in various locations, including on the roof of a building, on the side of a building, and/or on the ground. The antennas 10 are fed by beamforming circuitry, which connects to modems via switching and redundancy circuitry. The modems communicate with one or more communication networks. The non-terrestrial station 20 can also be in communication with several other ground stations, which might include carrier or health monitoring stations, or remote user stations. The ground stations may use a single antenna 10 or multiple antennas 10. The antennas 10, used in ground stations, can also be mounted on convenient locations, including on roofs or on the sides of structures, such as buildings or towers. The antennas 10 can connect to modems, which may also include beamforming processors to support multiple antennas. Additional components (not shown) can connect the modems with one or more communication networks. In some embodiments, the non-terrestrial communication system can connect a plurality of communication networks 30-60 with one another.

FIG. 1B illustrates a non-terrestrial communication system 100 according to an embodiment. The system 100 uses an antenna array 103 for providing communication, for example, to and from the Internet. A non-terrestrial station 102 can communicate with a plurality of antennas 104 in the antenna array 103. An example of a non-terrestrial station 102 includes a communication satellite, a space station, a high-altitude balloon, or other communication endpoint located in the atmosphere or space. The gateway 106 can provide the software and hardware components to process communication signals for transmission to the non-terrestrial station 102 and to process communication signals received from the non-terrestrial station 102. The gateway 106 is in communication with one or more modems 108 to provide access and communication to the Network 110. An example of a network 110 can include the Internet. The described non-terrestrial communication methods and systems do not require a specific pre-known displacement between the antennas 104 of the antenna array 103. As will be described, compared to the traditional single antenna ground stations, the flexible antenna array 103 provides various advantages. The term array in the antenna array 103 should not be construed to mean the antennas 104 have to be installed with a pre-specified distance to one another.

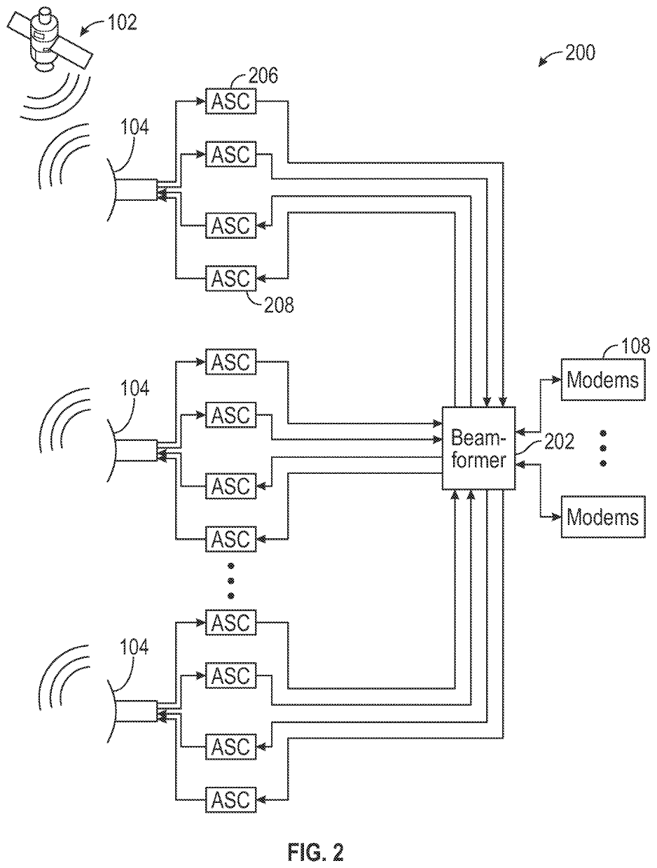

FIG. 2 illustrates a block diagram 200 of an example overview of some additional components in the gateway 106 of the embodiment of FIG. 1B. For example, in some embodiments, the gateway 106 can include analog signal conditioning (ASC) blocks 206, 208. In some embodiments, the ASC blocks 206 can be low-noise block down converters (LNBs). In some embodiments, the ASC blocks 208 can be block upconverters (BUCs). The ASC blocks 206, 208 can perform analog signal conditioning, such as amplification, up/down conversion, filtering, etc. In some embodiments, beamformers 202 can perform direct conversion to/from the carrier frequency. In this scenario, the ASC blocks 206, 208 can be implemented with amplifiers. ASC blocks 206, 208 can be in communication with the beamformers 202. The beamformers 202 can communicate with the modems 108. The beamformers 202 can include hardware and software components to equalize or align various transmission or reception signals to and from the non-terrestrial station 102 and/or the modems 108, such that the signals combine constructively. In some embodiments, the beamformers 202 can include functionality to convert the analog signals from the ASC blocks to or from digital signals before or after combining them. In these embodiments, the beamformers 202 can include one or more digitizers. Each antenna 104 can include one or more communication channels from the modems 108 through the beamformers 202, and the ASCs 206, 208 and terminating in an antenna 104. The antennas 104 communicate with the non-terrestrial station 102 via radio waves.

Compared to the described embodiments, traditional non-terrestrial station communication systems typically may use a single large dish antenna instead of the antenna array 103. Replacing a large single dish antenna with an antenna array 103 and a plurality of smaller antennas 104 can provide various advantages. Traditional single dish antennas can have the following characteristics, which can make their deployment challenging. For example, a monolithic dish antenna that can overcome the link loss to a non-terrestrial station can have a high cost of installation and take a long time to install. Furthermore, installation of monolithic dish antennas is difficult, requiring specialized staff and heavy equipment. Transportation of large monolithic dish antennas, particularly to remote areas, also presents another challenge in deploying them in non-terrestrial communication ground stations.

Several of such challenges can be addressed by deploying an array of smaller, relatively low-cost antennas, such as the antennas 104. The antennas 104 can be dish antennas. Example sizes of the antennas 104 can be in the order of 1-4 meters (m) in diameter. Depending on the selected sizes of the antennas 104 and the frequency of operation, the antennas 104 may not require active/motorized pointing to the non-terrestrial station 102. The antennas 104 can act as receivers that work with beamforming algorithms that require no coordination with the non-terrestrial station 102 and no specified, precise positioning or displacement of the antennas 104, relative to one another or to the non-terrestrial station 102.

The antennas 104 can also act as transmitters to the non-terrestrial station 102. On the transmission side, the described beamforming algorithms with feedback from the non-terrestrial station are able to perform beamforming to the non-terrestrial station over arbitrary channels with no specified, precise positioning of the antennas 104. In some embodiments, beamforming algorithms can be performed both in a ground station and a non-terrestrial station. In other embodiments, some beamforming algorithms can be performed exclusively in one or more ground stations.

The antenna array 103, utilizing small antenna elements, can confer a number of advantages. The antennas 104 can use non-penetrating antenna mounts, significantly reducing antenna installation cost and time. Assembly costs can also be reduced, and lower cost material can be used to manufacture the smaller antennas 104. Several emerging and developing markets for non-terrestrial communication technology can source the material for smaller antennas 104 through their local markets, compared to the cost of import, duties and logistics involved in using a large monolithic dish antenna.

Furthermore, since a non-terrestrial communication environment built using the described technology has low or no sensitivity to pre-specified antenna placement requirement, installation cost and difficulty can be substantially less compared to installation of large antennas or antenna arrays that require adherence to specified antenna placement. Flexibility in antenna placement, combined with the ability to use non-penetrating antenna mounts, can also allow for easier installation in places and in times where a full antenna foundation installation would otherwise be cumbersome and expensive (e.g., antenna installation in Alaska, Siberia, or similar locations during winter). The flexibility provided by the antennas 104 can also mean the antennas can be placed where possible, available, or convenient, as opposed to being restricted to a limited installation space. For example, the antennas 104 can be installed on roofs, sides of a building or other available convenient or available locations.

Compared to the large dish antennas, the antennas 104 and related equipment can be shipped via standard shipping channels, without requiring heavy transportation machinery. The smaller size of the antennas 104 and the antenna array 103 can mean sites that might have otherwise been unable to accommodate non-terrestrial communication equipment can enjoy a ground station by deploying smaller, more flexible antennas 104. The small size of the antennas 104 can also allow ground station technicians to maintain spare parts more conveniently at a site and to be able to provide faster failure response times.

The flexibility of the antennas 104 can also extend to the number of antennas 104, which can be used in a non-terrestrial communication ground station. For example, based on the requirements of a mission, antennas can be added or removed from the described communication systems and methods.

The antennas 104 can use a common, easy-to-install base/foundation to limit antenna element-element mis-pointing to the non-terrestrial station, due to soil moisture changes. This can increase their reliability and decrease maintenance cost and complexity.

The antennas 104 and their associated equipment can be more conveniently relocated compared to traditional dish antennas, allowing for use in multiple missions, reducing overall system cost over time. The flexibility and ease in relocation can allow for the ability to adjust to interferers by moving the antennas 104 to a new site or to adjust site position to comply with regulatory issues. Ease of relocation can also allow for site relocation in the case of a customer/contract change.

The antenna array 103 can be designed for shipping and deployment in standard dimension shipping containers determined by the number of antennas 104 in the planned ground station. Typical commercially available 20′ and 40′ shipping containers can be used in most installations. Additionally, specially modified containers may be used, when needed, for ground stations that require operating space for electronic equipment related to the ground station. Containers may be outfitted with HVAC, insulation, and utility connections (as needed). In some cases, some or all of the antennas 104 may be mounted directly to the container using either non-penetrating mounts or a custom mounting solution. This highly mobile deployment configuration can allow for shipping, installation, operation, and relocation via a single containerized package.

Given these procurement, shipping, installation, and placement advantages, a ground station based on the antenna array 103 can be deployed rapidly. This can allow an operator of a non-terrestrial communication system, utilizing the described embodiments, to respond more quickly to changing demands in their network.

Since in the described embodiments, non-terrestrial communication can be performed with multiple antennas 104, each antenna 104 and its associated equipment and communication channels can be isolated and maintained separately, with low or no interruption to the overall communication to the non-terrestrial station. The ground station utilizing the flexible antennas 104 can therefore be more resilient to failures, as non-terrestrial communication is distributed through multiple antennas 104, as opposed to a single dish antenna. The maintenance process is also streamlined and can be done without taking the system down in most cases.

The small size of the antennas 104 can in many cases enable them to operate without an HVAC system in the antenna elements, reducing complexity and operation costs.

The flexible antennas 104 are able to create beams to several non-terrestrial stations at the same time, increasing flexibility and allowing for sharing of a gateway between multiple non-terrestrial stations, reducing overall mission costs.

The described embodiments can include beamforming algorithms for signals received from the non-terrestrial station 102, which can be referred to as reception-side beamforming algorithms. The challenge in the case of reception-side is that the spatial position of each antenna 104 is not necessarily known. Furthermore, the cable lengths and analog responses of each antenna 104 can vary. To facilitate beamforming and constructively combine signals from multiple antennas 104, the signals received from each antenna are aligned in magnitude, phase, and delay.

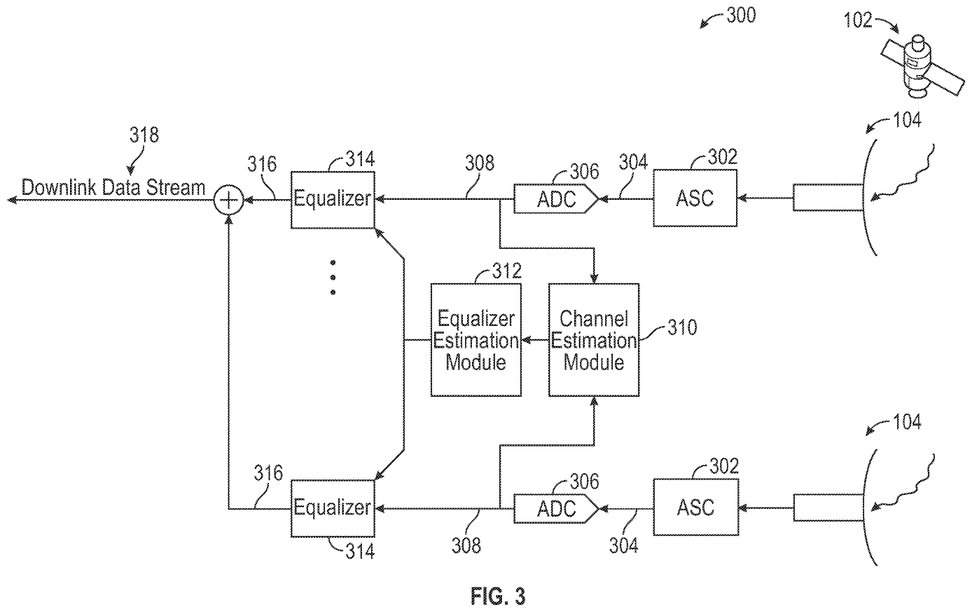

FIG. 3 illustrates a block diagram 300 of an example of components used in the reception-side beamforming. The antennas 104 receive the radio wave signals from the non-terrestrial station 102 and convert the radio wave signals to analog signals. ASC blocks 302 can perform analog signal processing to generate analog signals 304. In some embodiments, the ASCs 302 can be low-noise block downconverters (LNBs), which can amplify, and in some cases, can shift the frequency of the analog signals. Analog to digital converters (ADCs) 306 can convert the analog signals 304 to digital signals 308. For ease of illustration only two channels are shown; however, more antennas 104 and more corresponding channels and equipment can also be used. In some embodiments, an “in-phase,” and “quadrature” signal data (I/Q data) from the output of each ADC 306 can be used to estimate equalizer coefficients, which can be used to align or equalize the digital signals 308 before adding them together. Equalization or alignment in this context refers to receiving signals that can vary in phase and magnitude over frequency, and outputting signals that are flat in magnitude and phase relative to each other for all frequencies over a bandwidth.

In some embodiments, the digital signals 308 from the output of the ADCs 306 can be used in a channel estimation module 310. An ADC output digital signal 308 is selected as a reference signal and other ADC output digital signals 308 are correlated with the reference signal to estimate them relative to the reference signal. An equalizer estimation module 312 can calculate equalization parameters that when applied to a digital signal 308 would equalize the digital signal 308 relative to the reference signal. Equalizers 314 apply the equalization parameters received from the equalizer estimation module 312 to the digital signals 308 to generate equalized signals 316. The equalized signals 316 can be added together to generate the downlink data stream 318. In some embodiments, the channel estimation module 310 utilizes a least square channel estimation technique. The equalizers 314 can be finite impulse response (FIR) equalizers and the equalizer estimation module 312 can generate the filter taps for the equalizers 314.

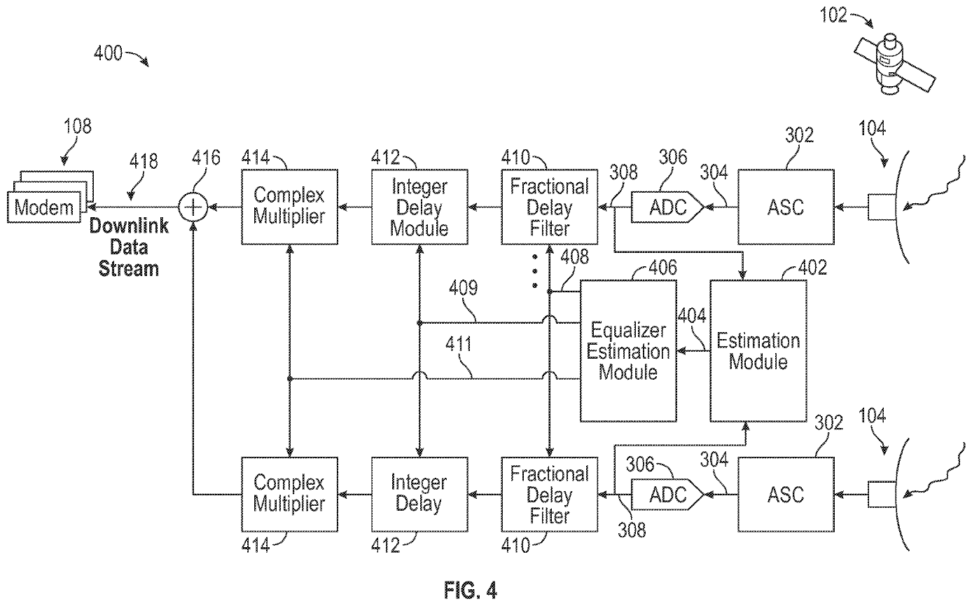

FIG. 4 illustrates a block diagram 400 of another example of components used in reception-side beamforming. For ease of illustration, only two channels and associated components for two antennas 104 are shown, but more channels and equipment, corresponding to more antennas 104 are also possible. The antennas 104 convert the radio waveforms received from the non-terrestrial station 102 to analog signals. ASC blocks 302 can perform analog signal processing to generate the analog signals 304. In some embodiments, the ASCs 302 can be LNBs, which can amplify, and in some cases, can shift the frequency of the received analog signals. The ADCs 306 convert the analog signals 304 to digital signals 308. The I/Q data from the output of each ADC 306 can be used to estimate the delay, gain and/or phase difference between each channel. The estimates can be used to equalize the channels before adding them together.

The beamforming algorithms described herein do not require a specific location of each antenna 104, relative to the other antennas 104. One of the digital signals 308 can be selected as a reference signal or reference channel, and the remaining digital signals 308 can be equalized relative to the reference signal. In some embodiments, the digital signal 308 with the largest magnitude can be selected as the reference signal.

To reduce reference channel oscillatory changes, some selected hysteresis values (e.g., 1 dB) can be applied to the magnitude measurements used in selecting the reference signal, allowing for some noise in the measurement. This can reduce or prevent the reference channel from oscillating between two channels with similar power levels. The reference channel selection algorithm can also be robust enough to avoid selection of anomalous channels as the reference channel. In some embodiments, the peak-average ratio of a best polyphase correlator path for each channel can be used to determine when a channel does not carry the same data as the other channels. More details of the polyphase correlator, used in some embodiments, are described below. Any channel with insufficient peak-average ratio can be excluded from selection as a reference channel. If more than half the channels have poor peak-average ratio, the current reference channel is excluded from being the reference channel until its peak-average ratio increases above a selected threshold.

Gain, Phase and/or Fractional Delay Estimation

In some embodiments, an estimation module 402 can be implemented to estimate a gain, phase, and/or delay from the outputs of the ADCs 306. These estimates can be used to perform equalization or alignment for the various channels received from each antenna 104. In some embodiments, the estimation module 402 need not estimate all parameters of a channel; instead, alignment can be performed by an estimation of gain, phase and/or delay of each channel instead of generating a more detailed model of the channel. In some embodiments, the delay of each channel relative to the reference channel can be estimated using a polyphase correlator bank. For a bank with M phases, each correlator can be offset by 1/M samples in time. Each correlator can calculate the correlation between the fractionally shifted (by m/M samples) digital signal 308 with the samples from the reference digital signal 308. The peaks from each correlator can be compared, and the correlator with the largest peak magnitude can be selected as estimating the lag the best. The integer lag of this peak is offset by the fractional delay of the best correlator, giving a total lag of L=L0+m0/M, where L0 is the integer lag from the polyphase correlator and m0 is the index of the correlator with the highest magnitude peak. The complex coefficient of that peak is the gain and phase estimate of that channel.

While the estimation module 402 can be implemented with a least-squares fractional delay estimate for each channel, the channel estimation using gain, phase and/or fractional delay estimation for each channel, as described above, can be more efficient. Estimation, using the described technique, can be more efficient than attempting to find the least-squares fractional delay for each channel because a fractional delay filter can have a complicated impulse response, where the error function and its derivatives may not be trivial to calculate. Since channel variations in many situations are not expected to vary quickly (likely on a timescale of seconds to minutes), the added computational load of the polyphase correlator is not expected to reduce performance.

### Example Equalization Algorithm

An equalizer estimation module 406 can receive the gain, phase, and/or delay estimates of channels (GPD estimates 404) from the estimation module 402 and produce filter coefficients 408, integer delays 409 and complex multipliers coefficients 411.

The complex coefficient of the peak polyphase correlator output can be used to normalize the gain and phase of each channel. Normalization in this context can refer to compensation, alignment, or equalization. In some embodiments, gain normalization can be skipped because normalization of a channel, in some cases, can also lead to an undesirable amplification of the noise on a channel. The equalizer estimation module 406 can generate complex multiplier coefficients 411. The complex multiplier coefficients 411 can either take the form |c_0|exp(−j angle(c_0)) if gain and phase compensation are used, or exp(−j angle(c_0)) if only phase compensation is used. “c_0” is the complex correlation value at the peak delay from the polyphase correlator bank for a given channel and j is the square root of −1. So, each channel can have a c_0, which in turn can be used to calculate the gain and phase offsets for that channel. If gain and phase compensation is used, the complex multiplier coefficient 411 of the reference channel is mean (magnitude of c_0s from other channels) exp(−j angle(c_0 of reference channel)). If only phase compensation is used, the complex multiplier coefficient 411 of the reference channel is exp(−j angle(c_0 of reference channel)). In other words, in some embodiments, the magnitude of c_0 for the reference channel is selected to be to the mean of the magnitudes of the remaining channels. This selection of complex coefficient 411 for the reference signal can mitigate an issue where the autocorrelation peak of the reference channel can grow compared to the cross-correlation peaks for other channels as the signal to noise ratio (SNR) decreases.

The equalizer estimation module 406 can generate filter coefficients 408 for the fractional delay filters 410 and integer delays 409 for the integer delay modules 412. In some embodiments, the fractional lag estimated above can be used to calculate the coefficients of a Lagrange interpolation fractional delay filter 410. In some embodiments, the fractional delay filter 410 can be a FIR filter. The filters 410 can be maximally flat in the frequency domain. In some embodiments, the filters 410 are relatively short and the coefficients of the filters 410 are infrequently updated. Therefore, recalculating the filter coefficients 408, when the fractional delay changes, does not impede the efficiency of the algorithm substantially.

Furthermore, in some embodiments, the fractional delay filters 410 can be centered around

$$\frac{K - 1}{2} ,$$

where K is the filter length. The delay of each filter can be

$${Δ}_{n} = {δ}_{n} + \frac{K - 1}{2} ,$$

where δₙ is the fractional delay of a channel “n”. Because the extra delay is present in each path, the equalizer performance is not impacted by the additional delay.

For a given delay Δ and filter length K, the coefficients 408 of the Lagrange fractional delay filters 410 are given by the Equation (1) below.

$${h}_{Δ , n} [ k ] = {{\prod }_{{P = 0}_{p \neq k}}}^{K - 1} \frac{Δ - P}{k - P} \qquad Equation ( 1 )$$

h_{Δ,n}[k] is the “k”th coefficient of the filter coefficient 408 associated with the “n”th channel. The filter coefficients 408 can be alternatively referred to as the fractional delay filter coefficients.

The described embodiments above are provided as one example of implementation of a fractional delay filter 410. Other implementations of a fractional delay filter 410 can also be used.

The lags or GPD estimates 404 from the estimation module 402 can be converted to delays by subtracting the lags for each channel from the maximum lag across all channels. For example, for channel n,

$${d}_{n} = {( max}_{0 \leq p < N} {L}_{p} ) - {L}_{n} \qquad Equation ( 2 )$$

Lₙ is the total lag calculated by the polyphase correlators for the “n”th channel, dₙ is the total delay for channel n, Dₙ is the integer delay for channel n (Dₙ=round (dₙ)), then the fractional delay for a channel “n”, “δₙ can be defined as,

$${δ}_{n} = {d}_{n} - {D}_{n} . \qquad Equation ( 3 )$$

In some embodiments, a hysteresis value can be applied to Dₙ, so that its value changes when the total delay changes from the last saved value by more than a selected threshold number of samples (e.g., 2 samples). This can reduce the update rate of the integer delays 409.

Each digital signal 308 is processed through a fractional delay filter 410, an integer delay module 412 and a complex multiplier 414. The fractional delay filter 410 receives a digital signal 308 and applies the filter coefficients 408 to the digital signal 308. The integer delay module 412 receives the output of the fractional delay filter 410 and applies the integer delays 409 to them. The complex multiplier 414 receives the output of the integer delay module 412 and applies the complex multiplier coefficients 411 to them. The outputs of the complex multipliers 414 are added together by an adder 416 to generate the downlink data stream 418.

In some embodiments, the operations of the fractional delay filter 410 and the complex multiplier 414 can be combined. This can be achieved by multiplying the filter coefficients 408 by the complex multiplier coefficients 411. In this scenario, the fractional delay filters 410 and complex multipliers 414 can be a single block.

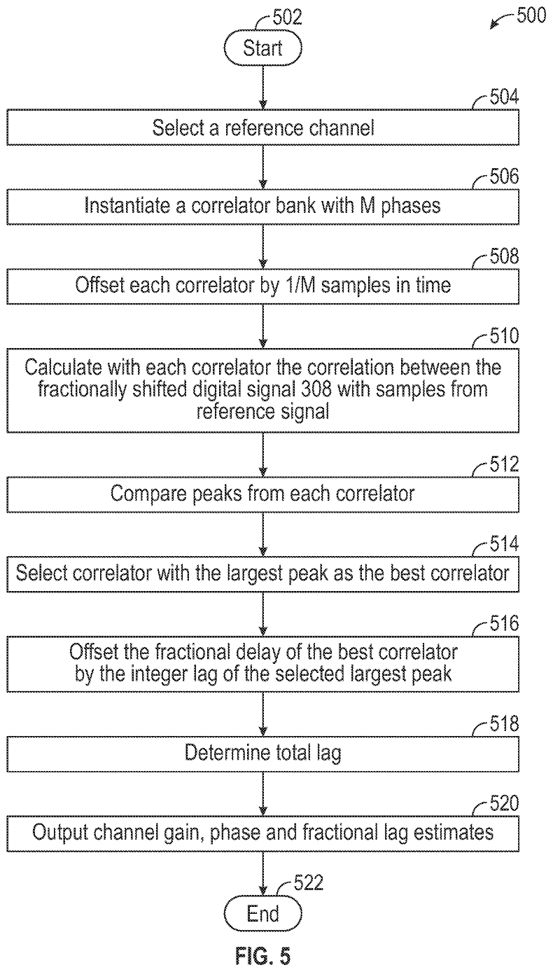

FIG. 5 illustrates an example flowchart of a method 500 of estimating channel parameters, such as gain, phase and/or delays according to an embodiment. The method starts at step 502. At step 504, a reference channel is selected. At step 506, a polyphase correlator bank with M phases is instantiated. At step 508, each correlator is offset by a factor 1/M samples in time. At step 510, each correlator can calculate a correlation between the fractionally shifted digital signal 308 with samples from the reference signal. At step 512, the peaks from each correlator are compared to one another. At step 514, the correlator with the largest magnitude peak is selected as the best correlator. At step 516, the fractional delay of the best correlator is offset by the integer delay of the selected largest peak. At step 518, a total lag is determined. At step 520, gain, phase and/or fractional lag estimates of a channel is output. The method ends at step 522.

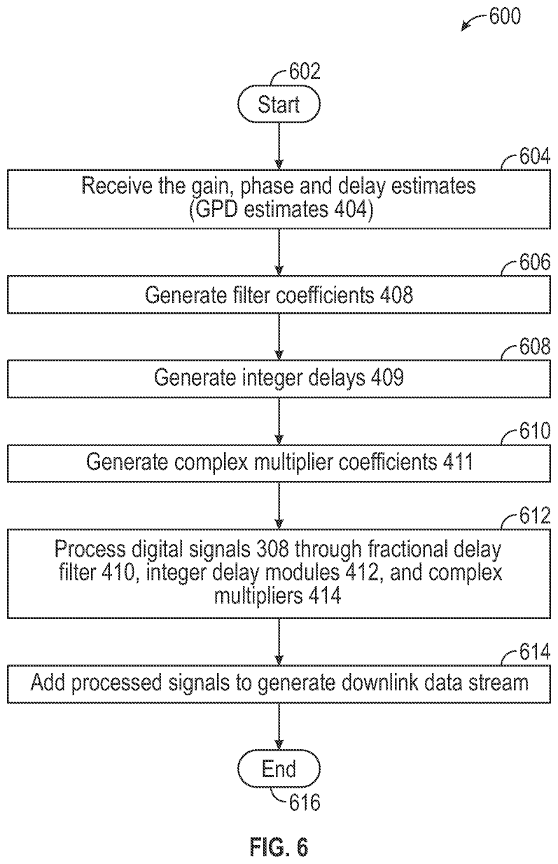

FIG. 6 illustrates an example flowchart of a method 600 of using the estimated gain, phase and/or delays to equalize the digital signals 308. Referring to both FIGS. 4 and 6, the method starts at step 602. At step 604, gain, phase and/or delay estimates (GPD estimates 404) are received. The GPD estimates 404 can be generated by a variety of methods, including for example by the method 500 described above. At step 606, the equalizer estimation module 406 generates filter coefficients 408. At step 608, the equalizer estimation module 406 generates integer delays 409. At step 610, the equalizer estimation module 406 generates complex multiplier coefficients 411. At step 612, the digital signals 308 are processed through the fractional delay filters 410, integer delay module 412, and the complex multipliers 414. At step 614, the processed signals are combined together to generate the downlink data stream 418. The method ends at step 616.

### Transmission-Side Beamforming

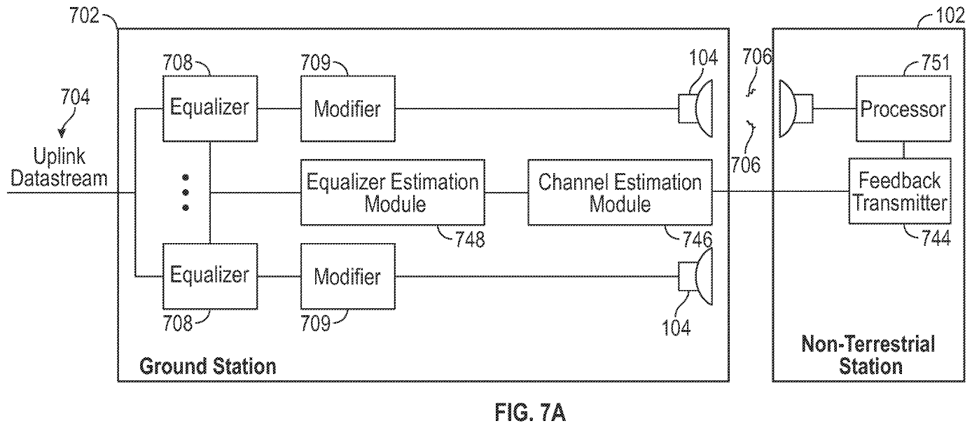

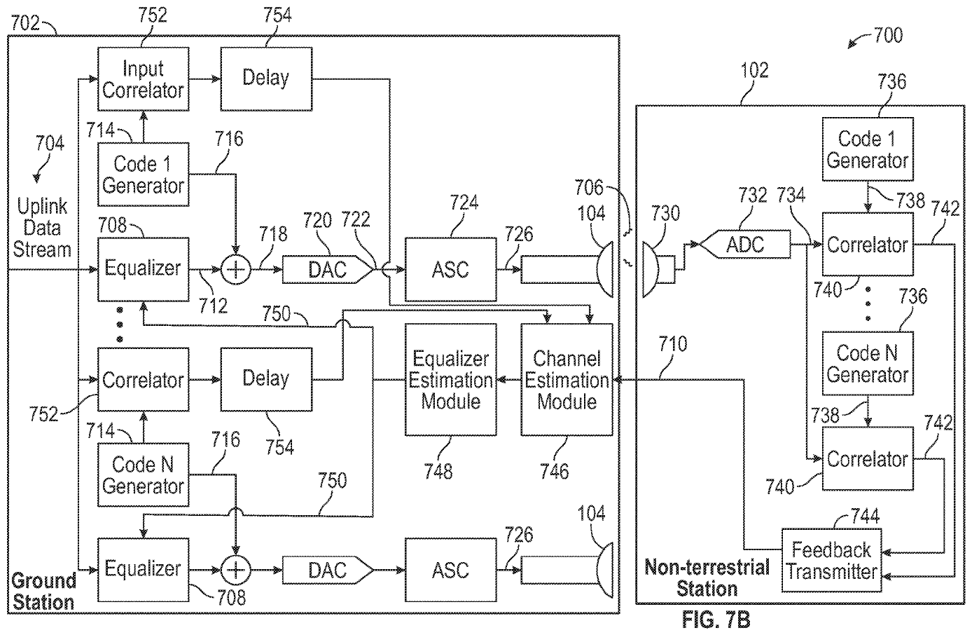

FIG. 7A illustrates a block diagram of an example of components used in transmission-side beamforming. Using the described embodiments, the non-terrestrial station 102 is in communication with a ground station 702. The ground station 702 can receive an uplink data stream 704 from one or more modems and transmit one or more radio waves 706 via a plurality of antennas 104 to the non-terrestrial station 102. For ease of illustration only two transmission channels and associated components and antennas 104 are shown; however, more transmission channels and corresponding components and antennas 104 can also be used. The described embodiments can be used to align the radio waves 706, so that the radio waves 706 combine constructively at the non-terrestrial station 102.

In some embodiments, the alignment can be achieved by applying an equalizer 708 to each channel. An example of the equalizer 708 is a finite-impulse response (FIR) equalizer. Another example of the equalizer 708 is a fractional delay filter similar to the fractional delay filter 410 described above in relation to the embodiment of FIG. 4. The weights for the equalizer 708 can be estimated by uniquely modifying the signals sent by each antenna 104 to the non-terrestrial station 102, processing those signals on the non-terrestrial station with a processor 751, and using the results of that processing to estimate new coefficients. The equalized signals can be modified by a modifier 709. In some embodiments the results of the processor 751 can be sent from the non-terrestrial station 102 back to the ground station 702, via a feedback transmitter 744 to aid in equalizer coefficient estimation, performed by a channel estimation module 746 and/or an equalizer estimation module 748.

In some embodiments, the modification of the signal can be achieved by adding predetermined codes to the signal transmitted by each antenna 104, as shown in FIG. 7B and discussed below. In other embodiments, a series of tones could be inserted in the signal transmitted by each antenna 104. In yet other embodiments, the data of the signal itself could be modified, such as by adding a unique header on each separate transmission path.

FIG. 7B illustrates a block diagram 700 of another example of components used in transmission-side beamforming. Using the described embodiments, the non-terrestrial station 102 is in communication with the ground station 702. The ground station 702 can receive an uplink data stream 704 from one or more modems and transmit one or more radio waves 706 via a plurality of antennas 104 to the non-terrestrial station 102. For ease of illustration only two transmission channels and associated components and antennas 104 are shown; however, more transmission channels and corresponding components and antennas 104 can also be used. The described embodiments can be used to align the radio waves 706, so that the radio waves 706 combine constructively at the non-terrestrial station 102.

In some embodiments, the alignment can be achieved by applying an equalizer 708 to each channel. An example of the equalizer 708 is a finite-impulse response (FIR) equalizer. Another example of the equalizer 708 is a fractional delay filter similar to the fractional delay filter 410 described above in relation to the embodiment of FIG. 4. The weights for the equalizer 708 can be estimated in part by transmitting a different orthogonal code on each antenna 104 and receiving a correlation back from the non-terrestrial station 102 through a feedback signal 710.

When sufficiently long codes are selected, the codes can be placed well below the data signal (e.g., 20 dB less power) and can be found on the non-terrestrial station 102 through a correlation. The non-terrestrial station 102 can transmit a feedback signal 710 back to the ground station 702. As will be described, the feedback signal 710 can be used to align the channels. The channel estimation and equalization can be performed in a variety of ways. One example will be provided below.

The equalizer 708 receives the uplink data stream 704 and generates an equalized signal 712. The ground station 702 can include code generators 714. A code generator 714 can generate a code signal 716 and add the code signal 716 to the equalized signal 712 to generate the code-embedded equalized signal 718. The code-embedded equalized signal 718 can be a digital signal. A digital to analog converter (DAC) 720 converts the code-embedded equalized signal 718 to an analog signal 722. An ASC 724 can perform analog signal processing and/or conditioning to generate conditioned analog signal 726. In some embodiments, the ASC 724 can be a block upconverter (BUC), which can convert the frequencies of the analog signal 722 to higher frequencies and, in some cases, can amplify the resulting signal to generate the conditioned analog signals 726. The antenna 104 converts the output of the ASC 724, or the conditioned analog signals 726, to radio waves 706 and transmits them to the non-terrestrial station 102. Other channels in the ground station 102 generate radio waves 706 using the same or similar components and pathways, as described above. The radio waves 706 are received by an antenna 730 in the non-terrestrial station 102. The antenna 730 can convert the radio waves 706 to an analog signal.

An ADC 732 in the non-terrestrial station 102 can convert the analog signal received from the antenna 730 to a digital signal 734. A code generator 736 can generate a code signal 738. The code generator 736 in the non-terrestrial station can use the same code generation algorithm as the code generator 714 in the ground station. Consequently, the code signals 738, generated in the non-terrestrial station, can be the same as the code signals 716, generated in the ground station. A correlator 740 can receive a code signal 738 from the code generator 736 and generate a correlation or representation of a channel. For example, in some embodiments, the correlator 740 can generate a representation of a channel response from the output of the DAC 720 in the ground station to the input of the ADC 732 in the non-terrestrial station. The code signals 738 can allow a correlator 740 to detect a correlation 742 between the channels in the digital signal 734 with the codes in the code signal 738 and be able to distinguish a channel corresponding to a code signal 738 from amongst the various channels received through the antenna 730. A feedback transmitter 744 can receive the correlations 742 and can transmit them to the ground station 102 via a feedback signal 710. Various transmitter hardware and software components can be used. For example, in some embodiments, the transmitter 744 can be implemented by a telemetry stream.

The feedback signal 710 can include the correlations 742. A channel estimation module 746 can receive the correlations 742 and can use them to estimate channel parameters relative to one another. Example channel parameters include gain, phase, equivalent filter coefficients, and/or delay for the various channels transmitted to the non-terrestrial station. An equalizer estimation module 748 can receive the relative channel parameters and can generate filter equalizer coefficients 750. The equalizers 708 can apply their respective equalizer coefficients 750 to the uplink data stream to generate corresponding equalized signals 712. The equalizer coefficients 750 are selected such that the radio waves 706 transmitted through the antennas 104 arrive at the non-terrestrial station antenna 730 in phase and can combine constructively across all frequencies within the bandwidth of the uplink signal.

In some cases, the code signals 716 may not be entirely orthogonal with the uplink data stream 704 causing corruptive cross-correlation between the code signal 716 and the equalized signal 712. In this scenario, to improve the channel estimates by the channel estimation module 746, a ground station input correlator 752 can correlate the code signal 716 and the uplink data stream 704. The correlations can be subtracted from the channel estimates after passing through delays 754 to compensate for the round-trip time it takes for the signals to reach the non-terrestrial station 102, and for the correlation information to be received by the ground station 702. By doing so, the channel estimation module 746 can produce more accurate channel estimates.

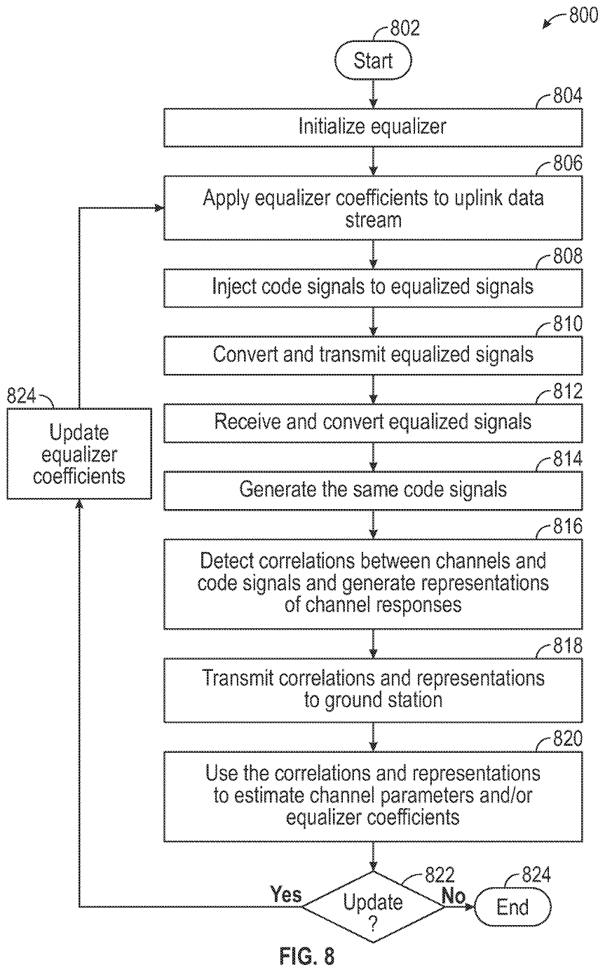

FIG. 8 illustrates a flowchart of an example transmission-side beamforming method 800, which can be used in a ground station utilizing multiple antennas 104 to communicate with the non-terrestrial station 102. The method starts at step 802. Referring to both FIGS. 7 and 8, at step 804, the equalizers 708 are initialized. For example, in some embodiments, where a FIR equalizer 708 is used, the impulse response of the FIR filters can be set to 1 for a selected range of frequencies and zero for the remaining frequencies. At step 806, the equalizer coefficients are applied to the uplink data stream 704. At step 808, the code signals 716 generated by the code generators 714 can be injected or added into the output of the equalizers 708. At step 810, the equalized and code-embedded signals can be converted to radio waves and transmitted to the non-terrestrial station 102.

At step 812, a non-terrestrial station antenna 730 and ADC 732 can receive the radio waves 706 and can convert them to digital signals 734. At step 814, the non-terrestrial station code generators 736 can generate the same code signals 738 as the code signals 716 in the ground station. At step 816, the non-terrestrial station correlators 740 can use the code signals 738 to detect correlations between the received channels and the code signals 738 and to generate representations of the channel responses. The representation of channel responses can be estimates of channels performed at the non-terrestrial station by the correlators 740 and/or other components. In some embodiments, the representations include channel responses from one point in the path of a channel to another point (e.g., from the output of the DACs 720 to the inputs of the ADCs 732). At step 818, the correlations and the representations of the channel responses can be transmitted to the ground station. At step 820, the correlations and the representations can be used to perform channel estimation and/or to generate updated equalizer parameters. The updated equalizer parameters are equalizer coefficients that when applied to the uplink data stream will shift a channel in gain, phase and/or delay by an amount, so that all channels arrive at the non-terrestrial station in phase.

At step 822, it is determined whether the channels are arriving at the non-terrestrial station misaligned (e.g., out of phase). If yes, the method moves to step 824, where the equalizer coefficients are updated, based on the estimates of the step 820 to shift the channels, such that they arrive at the non-terrestrial station in phase. The method moves to the step 806, where the equalizers apply the updated equalizer coefficients. At step 822, if it is detected that the channels are arriving at the non-terrestrial station in phase, the method ends at step 824. Alternatively, the step 822 can be performed continuously to monitor that aligned channels are delivered to the non-terrestrial station.

### Alternative Embodiments and Associated Advantages

The following various potential embodiments can be used and related advantages can be realized. For example, redundancy protection for a ground station utilizing the described embodiments can be provided, for example, by performing beamforming locally on a digitizer, with digitizer-digitizer combining occurring for larger arrays on a separate device and using one or more redundant digitizers with RF switches to allow for one or more digitizers to fail with no impact on the overall ground station system. Redundancy can also be provided by dedicating one digitizer to each antenna. In this embodiment, a single failure from an antenna back through the digitizer has an isolated impact on the overall ground station system. With this built-in soft failure in arrays, this implementation allows for a cost-effective, simple implementation. Another redundancy advantage, which can be realized by utilizing the described technology includes ability to build some systems and subsystems with more cost-effective equipment, since antennas 104 and antenna elements are less likely to fail at the same time. Replacing a single antenna 104 and/or associated elements can be done more easily, and in many cases, without taking the overall communication system offline. Redundancy protection is further improved since using the described technology, single-thread or non-redundant components can be used with reduced or minimal impact in case of a failure, since there is system-level redundancy due to the use of multiple antennas 104. Nonetheless, additional redundancies can be implemented by using redundant components, such as hot or cold spares that can be activated with manual or automatic switches.

Some implementations of the antennas 104 can be used in combination with motorization and/or tracking in antenna base. However, using antennas that are small-enough, such that their beamwidth is wide-enough to cover the orbital slot/coverage area with an acceptable amount of loss can allow for the antennas to be fixed mechanically and perform scanning and/or tracking electrically. Nonetheless, larger antennas 104 can be used with motorization or other mechanical pointing/steering methods that allow for use of larger antennas. In some embodiments, each antenna can track independently, removing the need to coordinate between the antenna elements and their associated components. In some embodiments, antennas can cooperatively track using initial or recurring calibration to align the antenna motors.

In some embodiments, masts can be used to elevate the antennas above obstructions. In some embodiments, individual concrete footings for mounts can be used. Examples include, using Sonotube at the corners of the antennas instead of a monolithic reinforced slab.

In some embodiments, a “balanced” array 103 can be used, in which each antenna 104 is used for both transmit-side and reception-side operations. Balanced arrays 103 can provide a high level of transmission and reception performance available from antennas 104 and associated hardware.

In some embodiments, an “unbalanced” array can be used, in which some subset of antenna elements is used for transmit-side operations and some subset of antenna elements is used for reception-side operations (with overlap allowed). This variant allows flexibility to meet transmit power and receive sensitivity requirements that would require a different number of antennas while still allowing for the use of the same transmit and receive hardware as other deployments and without the additional cost of hardware that is not needed to meet those requirements. For example: meeting transmit power requirements with a given antenna and amplifier size might only require three antennas, whereas meeting receive sensitivity requirements for a given antenna and LNB may require six. Therefore, three elements could be used as both transmission and reception elements and three could be used as reception elements only.

In some embodiments, the array 103 can include antennas 104 that are not the same, for example, the antennas 104 can differ in diameter. In some embodiments, the array 103 and the gateway 106 can include hardware that is collocated with the antennas 104, including RF, analog and digital hardware. In some embodiments, the hardware is partially collocated with the antennas 104, while some of the hardware is placed in another location (e.g., at the network hubs). Some embodiments place the digitizer 202 hardware in a structure adjacent to or nearby the antennas 104.

Some embodiments can be used as systems with RF hardware, such as LNBs, HPAs, BUCs, etc. that can cover one contiguous band. These might have a very wideband input or output bandwidth and can cover all or some portion of a desired band.

Some embodiments can be used with systems with RF hardware, such as LNBs, HPAs, BUCs, etc. that have multiple sub-band inputs or outputs. For example, an LNB with three 1 GHz wide inputs that can combine to cover all of 17.7-20.2 GHz (one from 17.7-18.7 GHz, one from 18.2-19.2 GHz, and one from 19.2-20.2 GHz).

Some embodiments can be used as systems with digital signal processing between modems and RF hardware (e.g., peak-average ratio reduction, digital pre-distortion, linear equalization, out of band filtering, etc.).

Some embodiments can include array combining techniques. For example, for the reception-side beamforming, antenna elements can be combined after aligning them in magnitude, phase, and/or delay. Channels add in voltage, but noise adds in power, resulting in an aggregate signal to noise ratio (SNR) gain of N\hat{ }2/N=N. This can scale the effective array gain by a factor of N, where N is the number of elements. Similarly, for the transmission-side beamforming the antenna elements can be combined after aligning them in magnitude, phase, and/or delay. This can scale the effective array gain by a factor of N\hat{ }2, as the channels add in voltage.

Some embodiments can be used with frequency-domain multiplexing techniques. For example, in some embodiments, each antenna element can be used to transmit a different set of frequencies. This can scale the effective array gain by a factor of N and can be done without any feedback from the non-terrestrial station receiver, or in some cases, without any calibration method. This also may allow for the power amplifiers on each element to be operated closer to saturation, as the signal bandwidth is reduced from the beamforming case.

As described, some embodiments include beamforming algorithms and components that improve the transmission-side beamforming by receiving a feedback signal. In some embodiments, the non-terrestrial station measures or estimates channel parameters, such as gain, phase, and/or delays of each channel and provides either these measurements, estimates or other derived products (e.g., correlations, channel representations, filter coefficients, etc.) down to the ground station via a downlink. The received feedback signal can be used to further improve the transmission-side beamforming. However, the non-terrestrial station is not the only entity that can generate and transmit the feedback signal. In some embodiments, carrier or health monitoring sites can provide the feedback signal. In this scenario, the non-terrestrial station operates as a “bent pipe” and re-transmits its received signals back to a ground station. The ground station receives the retransmitted signals and uses them to determine the transmit beamforming coefficients.

In some embodiments, sub-array beamforming can be used. Sub-array beamforming includes combining groups of antenna elements, with each group operating independently. Sub-array beamforming can be used, for example, at a redundant ground station site if the ground stations for two separate receivers were down. As an example, to implement sub-array beamforming, if a ground station includes eight antennas, four can be allocated to each receiver. Sub-array beamforming can be used in the reception-side, transmission-side or both, as each side can operate independently from one another.

In some embodiments, transmitting on only a subset of antenna elements can be used. For example, when the link allows it (e.g., clear sky), selective antenna transmission can reduce power consumption or avoid saturating a target receiver. Furthermore, selective antenna transmission can be more efficient than transmission via all available antennas, as the corresponding power amplifiers can run closer to saturation, allowing them to be more efficient.

In some embodiments, beamforming can be performed in the digital domain, with a digitizer behind each antenna element. In other embodiments, beamforming can be performing in the analog domain. In some embodiments, a hybrid beamforming approach can be used, with some sub-arrays beamforming in the analog domain, where each sub-array output is digitized for digital beamforming. Final beamforming in either case can be performed within the digitizer or can be done further back in the path. In some embodiments, some or a portion of the beamforming can be performed on a modem, a separate hardware (e.g., separate digitizer, dedicated beamforming processor, etc.), or on a combination of a modem and dedicated hardware.

The described embodiments can interface with a variety of communication systems to provide a downlink data stream and/or to receive an uplink data stream. Examples Systems with which the described embodiments can interface include: systems with digital interfaces, such as RF over IP (DIFI, VITA 49.2, or some other digital streaming protocol) and systems with analog interfaces. In interfacing with systems with analog interfaces, the intermediate beamformed digital data can undergo another digital-analog conversion back to an interface that is compatible with a modem (e.g., L-band, C-band, etc.).

### Example Implementation Mechanism—Hardware Overview

Some embodiments are implemented by a computer system or a network of computer systems. A computer system may include a processor, a memory, and a non-transitory computer-readable medium. The memory and non-transitory medium may store instructions for performing methods, steps and techniques described herein.

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be server computers, cloud computing computers, desktop computer systems, portable computer systems, handheld devices, networking devices or any other device that incorporates hard-wired and/or program logic to implement the techniques.

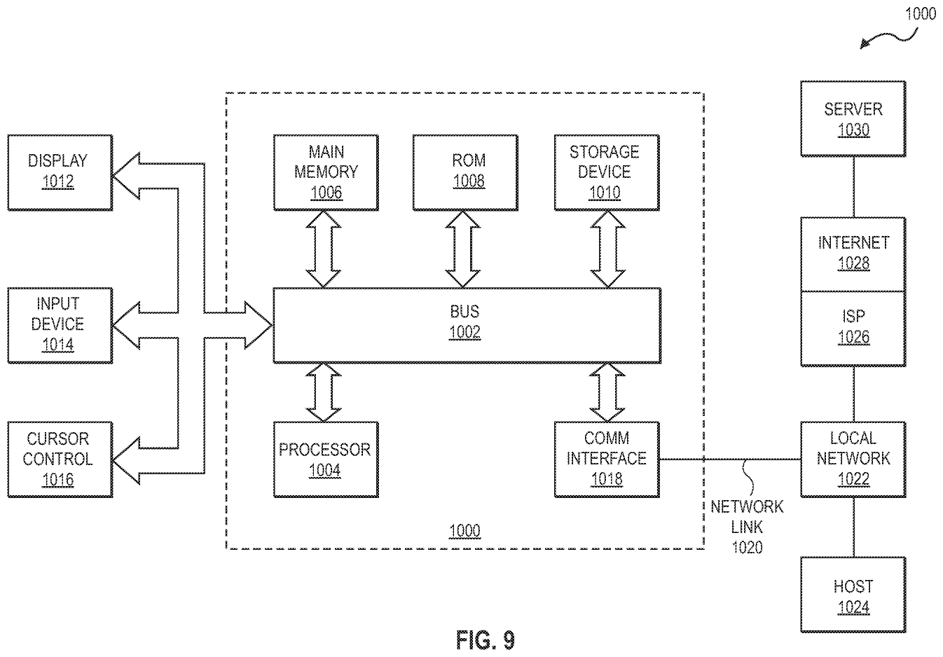

For example, FIG. 9 is a block diagram that illustrates a computer system 1000 upon which an embodiment of can be implemented. Computer system 1000 includes a bus 1002 or other communication mechanism for communicating information, and a hardware processor 1004 coupled with bus 1002 for processing information. Hardware processor 1004 may be, for example, special-purpose microprocessor optimized for handling audio and video streams generated, transmitted or received in video conferencing architectures.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid state disk is provided and coupled to bus 1002 for storing information and instructions.

Computer system 1000 may be coupled via bus 1002 to a display 1012, such as a cathode ray tube (CRT), liquid crystal display (LCD), organic light-emitting diode (OLED), or a touchscreen for displaying information to a computer user. An input device 1014, including alphanumeric and other keys (e.g., in a touch screen display) is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane. In some embodiments, the user input device 1014 and/or the cursor control 1016 can be implemented in the display 1012 for example, via a touch-screen interface that serves as both output display and input device.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical, magnetic, and/or solid-state disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infrared data communications.

Various forms of media may be involved in carrying one or more sequences of one or more instructions to processor 1004 for execution. For example, the instructions may initially be carried on a magnetic disk or solid state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018. The received code may be executed by processor 1004 as it is received, and/or stored in storage device 1010, or other non-volatile storage for later execution.

### EXAMPLES

It will be appreciated that the present disclosure may include any one and up to all of the following examples.

### Reception-Side Examples

Example 1: A method of communication comprising: receiving, by a plurality of antennas, radio waveforms from a non-terrestrial station, wherein the plurality of antennas comprise an arbitrary placement relative to one another, and not having a specified displacement between the plurality of the antennas; converting, by the plurality of the antennas, the radio waveforms to a plurality of analog signals, each analog signal comprising an analog signal channel; converting the analog signal channels, with a plurality of analog to digital converters, to a plurality of digital signals, each digital signal comprising a digital signal channel; choosing a reference signal from the digital signals; correlating the remaining plurality of the digital signals with the reference signal, wherein correlating comprises estimating equalization parameters for each digital signal, relative to the reference signal, wherein when equalization parameters are applied to each digital signal, the digital signals are equalized, relative to the reference signal, wherein estimating the equalization parameters are at least in part, based on data, received from the plurality of the analog to digital converters; generating equalized signals by applying the equalization parameters to the digital signals, such that the equalized signals when combined, combine constructively; generating a downlink data stream by combining the equalized signals; providing the downlink data stream to a modem; providing, by the modem, the downlink data stream to a communication network.

Example 2: The method of Example 1, wherein the equalization parameters comprise one or more of gain, phase, and delay estimates for each digital signal, obtained from the output of each analog to digital converter.

Example 3: The method of some or all of Examples 1 and 2, wherein the equalization parameters comprise one or more of gain, phase, and delay estimates for each digital signal, obtained from the output of each analog to digital converter, and wherein the estimating of the gain, phase, and delay in a digital signal, relative to the reference signal, comprises: initiating a correlator bank, with M phases; offsetting each correlator in the bank by 1/M samples in time; each correlator, calculating a correlation between a fractionally shifted digital signal with samples from the reference signal; comparing peaks from each correlator; selecting a correlator with the largest peak magnitude for estimating a delay between the digital signal and the reference signal; offsetting a fractional delay of the selected correlator by an integer lag of the selected largest peak; determining total lag comprising an integer lag from the correlator bank plus a ratio of an index of the correlator with the largest peak over M; and estimating the gain and phase of the digital signal, relative to the reference signal, based at least in part on a complex coefficient of the largest peak.

Example 4: The method of some or all of Examples 1-3, wherein the reference signal comprises the digital signal having the largest magnitude of the digital signals.

Example 5: The method of some or all of Examples 1-4, wherein the data, received from the plurality of the analog to digital converters comprise an “in-phase,” and “quadrature” signal data (I/Q data) from the output of each analog to digital converter.

Example 6: The method of some or all of Examples 1-5, wherein estimating equalization parameters further comprises estimating channels obtained from a least-squares estimator.

Example 7: The method of some or all of Examples 1-6, wherein the antennas are placed hundreds of wavelengths or more apart from each other.

Example 8: The method of some or all of Examples 1-7, wherein the antennas independently track the non-terrestrial station as it moves around in the sky.

Example 9: The method of some or all of Examples 1-8, wherein the antennas cooperatively track the non-terrestrial station as it moves in the sky.

Example 10: The method of some or all of Examples 1-9, wherein the non-terrestrial station comprises one or more satellites, and/or high-altitude balloons.

Example 11: The method of some or all of Examples 1-10, wherein the plurality of analog signals is amplified and down converted using components with a single wide operating band.

Example 12: The method of some or all of Examples 1-11, wherein the plurality of analog signals is amplified and down converted using components that cover several sub-bands.

Example 13: The method of some or all of Examples 1-12, wherein the plurality of analog signals is converted into a plurality of digital signals before choosing a reference signal and wherein the analog signals from each antenna element are converted into digital signals with circuitry dedicated to that antenna element.

Example 14: The method of some or all of Examples 1-13, wherein the plurality of analog signals is converted into a plurality of digital signals before choosing a reference signal and wherein the analog signals from each antenna element are converted into digital signals with circuitry shared between multiple antenna elements.

Example 15: The method of some or all of Examples 1-14, wherein the plurality of analog signals is converted into a plurality of digital signals before choosing a reference signal, wherein the analog signals from each antenna are converted into digital signals with circuitry shared between the plurality of the antennas, and wherein the analog signals are switched between multiple sets of circuitry before being converted into digital signals.

Example 16: A non-transitory computer storage that stores executable program instructions that, when executed by one or more computing devices, configure the one or more computing devices to perform operations comprising: receiving, by a plurality of antennas, radio waveforms from a non-terrestrial station, wherein the plurality of antennas comprise an arbitrary placement relative to one another, and not having a specified displacement between the plurality of the antennas; converting, by the plurality of the antennas, the radio waveforms to a plurality of analog signals, each analog signal comprising an analog signal channel; converting the analog signal channels, with a plurality of analog to digital converters, to a plurality of digital signals, each digital signal comprising a digital signal channel; choosing a reference signal from the digital signals; correlating the remaining plurality of the digital signals with the reference signal, wherein correlating comprises estimating equalization parameters for each digital signal, relative to the reference signal, wherein when equalization parameters are applied to each digital signal, the digital signals are equalized, relative to the reference signal, wherein estimating the equalization parameters are at least in part, based on data, received from the plurality of the analog to digital converters; generating equalized signals by applying the equalization parameters to the digital signals, such that the equalized signals when combined, combine constructively; generating a downlink data stream by combining the equalized signals; providing the downlink data stream to a modem; and providing, by the modem, the downlink data stream to a communication network.

Example 17: The non-transitory computer storage of Example 16, wherein the equalization parameters comprise one or more of gain, phase, and delay estimates for each digital signal, obtained from the output of each analog to digital converter.

Example 18: The non-transitory computer storage of some or all of Examples 16 and 17, wherein the equalization parameters comprise one or more of gain, phase, and delay estimates for each digital signal, obtained from the output of each analog to digital converter, and wherein the estimating of the gain, phase, and delay in a digital signal, relative to the reference signal, comprises: initiating a correlator bank, with M phases; offsetting each correlator in the bank by 1/M samples in time; each correlator, calculating a correlation between a fractionally shifted digital signal with samples from the reference signal; comparing peaks from each correlator; selecting a correlator with the largest peak magnitude for estimating a delay between the digital signal and the reference signal; offsetting a fractional delay of the selected correlator by an integer lag of the selected largest peak; determining total lag comprising an integer lag from the correlator bank plus a ratio of an index of the correlator with the largest peak over M; and estimating the gain and phase of the digital signal, relative to the reference signal, based at least in part on a complex coefficient of the largest peak.

Example 19: The non-transitory computer storage of some or all of Examples 16-18, wherein the reference signal comprises the digital signal having the largest magnitude of the digital signals.

Example 20: The non-transitory computer storage of some or all of Examples 16-19, wherein the data, received from the plurality of the analog to digital converters comprise an “in-phase,” and “quadrature” signal data (I/Q data) from the output of each analog to digital converter.

Example 21: The non-transitory computer storage of some or all of Examples 16-20, wherein estimating equalization parameters further comprises estimating channels obtained from a least-squares estimator.

Example 22: The non-transitory computer storage of some or all of Examples 16-21, wherein the antennas are placed hundreds of wavelengths or more apart from each other.

Example 23: The non-transitory computer storage of some or all of Examples 16-22, wherein the antennas independently track the non-terrestrial station as it moves around in the sky.

Example 24: The non-transitory computer storage of some or all of Examples 16-23, wherein the antennas cooperatively track the non-terrestrial station as it moves in the sky.

Example 25: The non-transitory computer storage of some or all of Examples 16-24, wherein the non-terrestrial station comprises one or more satellites, and/or high-altitude balloons.

Example 26: The non-transitory computer storage of some or all of Examples 16-25, wherein the plurality of analog signals is amplified and down converted using components with a single wide operating band.

Example 27: The non-transitory computer storage of some or all of Examples 16-26, wherein the plurality of analog signals is amplified and down converted using components that cover several sub-bands.

Example 28: The non-transitory computer storage of some or all of Examples 16-27, wherein the plurality of analog signals is converted into a plurality of digital signals before choosing a reference signal and wherein the analog signals from each antenna element are converted into digital signals with circuitry dedicated to that antenna element.

Example 29: The non-transitory computer storage of some or all of Examples 16-28, wherein the plurality of analog signals is converted into a plurality of digital signals before choosing a reference signal and wherein the analog signals from each antenna element are converted into digital signals with circuitry shared between multiple antenna elements.

Example 30: The non-transitory computer storage of some or all of Examples 16-29, wherein the plurality of analog signals is converted into a plurality of digital signals before choosing a reference signal, wherein the analog signals from each antenna are converted into digital signals with circuitry shared between the plurality of the antennas, and wherein the analog signals are switched between multiple sets of circuitry before being converted into digital signals.

Example 31: A system comprising one or more processors, wherein the one or more processors are configured to perform operations comprising: receiving, by a plurality of antennas, radio waveforms from a non-terrestrial station, wherein the plurality of antennas comprise an arbitrary placement relative to one another, and not having a specified displacement between the plurality of the antennas; converting, by the plurality of the antennas, the radio waveforms to a plurality of analog signals, each analog signal comprising an analog signal channel; converting the analog signal channels, with a plurality of analog to digital converters, to a plurality of digital signals, each digital signal comprising a digital signal channel; choosing a reference signal from the digital signals; correlating the remaining plurality of the digital signals with the reference signal, wherein correlating comprises estimating equalization parameters for each digital signal, relative to the reference signal, wherein when equalization parameters are applied to each digital signal, the digital signals are equalized, relative to the reference signal, wherein estimating the equalization parameters are at least in part, based on data, received from the plurality of the analog to digital converters; generating equalized signals by applying the equalization parameters to the digital signals, such that the equalized signals when combined, combine constructively; generating a downlink data stream by combining the equalized signals; providing the downlink data stream to a modem; providing, by the modem, the downlink data stream to a communication network.

Example 32: The system of Example 31, wherein the equalization parameters comprise one or more of gain, phase, and delay estimates for each digital signal, obtained from the output of each analog to digital converter.

Example 33: The system of some or all of Examples 31 and 32, wherein the equalization parameters comprise one or more of gain, phase, and delay estimates for each digital signal, obtained from the output of each analog to digital converter, and wherein the estimating of the gain, phase, and delay in a digital signal, relative to the reference signal, comprises: initiating a correlator bank, with M phases; offsetting each correlator in the bank by 1/M samples in time; each correlator, calculating a correlation between a fractionally shifted digital signal with samples from the reference signal; comparing peaks from each correlator; selecting a correlator with the largest peak magnitude for estimating a delay between the digital signal and the reference signal; offsetting a fractional delay of the selected correlator by an integer lag of the selected largest peak; determining total lag comprising an integer lag from the correlator bank plus a ratio of an index of the correlator with the largest peak over M; and estimating the gain and phase of the digital signal, relative to the reference signal, based at least in part on a complex coefficient of the largest peak.

Example 34: The system of some or all of Examples 31-33, wherein the reference signal comprises the digital signal having the largest magnitude of the digital signals.

Example 35: The system of some or all of Examples 31-34, wherein the data, received from the plurality of the analog to digital converters comprise an “in-phase,” and “quadrature” signal data (I/Q data) from the output of each analog to digital converter.

Example 36: The system of some or all of Examples 31-35, wherein estimating equalization parameters further comprises estimating channels obtained from a least-squares estimator.

Example 37: The system of some or all of Examples 31-36, wherein the antennas are placed hundreds of wavelengths or more apart from each other.

Example 38: The system of some or all of Examples 31-37, wherein the antennas independently track the non-terrestrial station as it moves around in the sky.

Example 39: The system of some or all of Examples 31-38, wherein the antennas cooperatively track the non-terrestrial station as it moves in the sky.

Example 40: The system of some or all of Examples 31-39, wherein the non-terrestrial station comprises one or more satellites, and/or high-altitude balloons.

Example 41: The system of some or all of Examples 31-40, wherein the plurality of analog signals is amplified and down converted using components with a single wide operating band.

Example 42: The system of some or all of Examples 31-41, wherein the plurality of analog signals is amplified and down converted using components that cover several sub-bands.

Example 43: The system of some or all of Examples 31-42, wherein the plurality of analog signals is converted into a plurality of digital signals before choosing a reference signal and wherein the analog signals from each antenna element are converted into digital signals with circuitry dedicated to that antenna element.

Example 44: The system of some or all of Examples 31-43, wherein the plurality of analog signals is converted into a plurality of digital signals before choosing a reference signal and wherein the analog signals from each antenna element are converted into digital signals with circuitry shared between multiple antenna elements.

Example 45: The system of some or all of Examples 31-44, wherein the plurality of analog signals is converted into a plurality of digital signals before choosing a reference signal, wherein the analog signals from each antenna are converted into digital signals with circuitry shared between the plurality of the antennas, and wherein the analog signals are switched between multiple sets of circuitry before being converted into digital signals.

### Transmission-Side Examples

Example 46: A method of communication comprising: receiving, at a ground station and from a modem coupled to a communication network, an uplink data stream, for transmission to a non-terrestrial station; initializing a plurality of equalizers, the number of equalizers corresponding to a number of transmission channels, selected for transmitting the uplink data stream to the non-terrestrial station; applying the plurality of the equalizers to the uplink data stream, each equalizer generating at least an equalized signal, wherein the equalized signals are modified such that the modified signals are distinct from each other when received at the non-terrestrial station, wherein the equalized signals are modified, at the ground station, by: generating a plurality of code signals; injecting a code signal in each equalized signal, generating a code-embedded equalized signal; transmitting the code-embedded equalized signals to the non-terrestrial station; receiving the code-embedded equalized signals with the non-terrestrial station antenna; generating the plurality of the code signals at the non-terrestrial station; generating a channel representation for each code-embedded equalized signal, by correlating the code-embedded equalized digital signals with the plurality of the code signals generated at the non-terrestrial station; estimating channel parameters using the channel representation; updating the equalizers, such that when updated equalizers are applied to the uplink data stream, the transmitted equalized signals arrive at the non-terrestrial station in phase; transmitting the equalized signals to the non-terrestrial station; and receiving the equalized signals with the antenna of the non-terrestrial station.

Example 47: The method of Example 46, further comprising: transmitting a feedback signal, the feedback signal, comprising information on the received equalized signals.

Example 48: The method of some or all of Examples 46 and 47, further comprising: transmitting a feedback signal, the feedback signal, comprising the channel representation for each code-embedded equalized signal.

Example 49: The method of some or all of Examples 46-48, further comprising: generating a feedback signal, comprising information on the received equalized signals wherein the feedback signal is generated at one or more of the non-terrestrial station, at an original ground station, or at a ground station different than the ground station, receiving the uplink data stream.

Example 50: The method of some or all of Examples 46-49: transmitting a feedback signal, comprising the channel representation for each code-embedded equalized signal; correlating the code signals with the uplink data stream, generating a cross-correlation; and estimating the channel parameters based on the channel representations and the cross-correlation received from correlating the code signals with the uplink data stream.

Example 51: The method of some or all of Examples 46-50, further comprising: transmitting a feedback signal, comprising the channel representation for each code-embedded equalized signal; correlating the code signals with the uplink data stream, generating a cross-correlation; and estimating the channel parameters based on the channel representations and the cross-correlation received from correlating the code signals with the uplink data stream, wherein estimating channel parameters comprises estimating one or more of gain, phase, equivalent filter coefficients, and delay values.

Example 52: The method of some or all of Examples 46-51, wherein the code-embedded equalized signals comprise digital signals, and the method further comprises: converting the code-embedded equalized signals to analog signals in the ground station and converting the code-embedded equalized signals to digital signals at the non-terrestrial station.

Example 53: The method of some or all of Examples 46-52, wherein the equalizers are finite impulse response (FIR) equalizers and applying the equalizers comprises applying equalizer coefficients to the uplink data stream.

Example 54: The method of some or all of Examples 46-53, wherein a plurality of antennas transmit the equalized signals, and the antennas use a non-penetrating method of mounting on a surface.

Example 55: The method of some or all of Examples 46-54, wherein a plurality of antennas placed in arbitrary locations, relative to one another, transmit the code-embedded equalized signals.

Example 56: The method of some or all of Examples 46-55, wherein a plurality of antennas transmit the equalized signals, and wherein the antennas are installed on the ground, on rooftops, and/or on sides of buildings in a deployment area.

Example 57: The method of some or all of Examples 46-56, wherein a plurality of antennas transmit the equalized signals, and wherein the antennas are placed hundreds of wavelengths or more apart from each other.

Example 58: The method of some or all of Examples 46-57, wherein a plurality of antennas transmit the equalized signals, and wherein the antennas are pointed in a fixed direction during the operations.

Example 59: The method of some or all of Examples 46-58, wherein a plurality of antennas transmit the equalized signals, and wherein the antennas independently track the non-terrestrial station as it moves around in the sky.

Example 60: The method of some or all of Examples 46-59, wherein a plurality of antennas transmit the equalized signals, and wherein the antennas cooperatively track the non-terrestrial station as it moves around in the sky.

Example 61: The method of some or all of Examples 46-60, wherein the non-terrestrial station comprises a satellite, or a high-altitude balloon.

Example 62: The method of some or all of Examples 46-61, wherein the equalized signals are upconverted and amplified using components with a single wide operating band, or with components that cover several sub-bands.

Example 63: The method of some or all of Examples 46-62, wherein the ground station comprises a plurality of antennas for transmitting the equalized signals, each equalized signal having a corresponding transmission channel, linked with an antenna, wherein the equalized signals comprise digital signals, and the digital signals are converted into analog signals with dedicated circuitry corresponding to each antenna, or with circuitry shared between multiple antennas.

Example 64: The method of some or all of Examples 46-63, wherein the ground station comprises a plurality of antennas for transmitting the equalized signals, each equalized signal having a corresponding transmission channel, linked with an antenna, wherein the equalized signals comprise digital signals, and the digital signals are converted into analog signals with dedicated circuitry corresponding to each antenna, or with circuitry shared between multiple antennas, and wherein the analog signals are switched between multiple sets of circuitry after being converted from digital signals.

Example 65: A non-transitory computer storage that stores executable program instructions that, when executed by one or more computing devices, configure the one or more computing devices to perform operations comprising: receiving, at a ground station and from a modem coupled to a communication network, an uplink data stream, for transmission to a non-terrestrial station; initializing a plurality of equalizers, the number of equalizers corresponding to a number of transmission channels, selected for transmitting the uplink data stream to the non-terrestrial station; applying the plurality of the equalizers to the uplink data stream, each equalizer generating at least an equalized signal, wherein the equalized signals are modified such that the modified signals are distinct from each other when received at the non-terrestrial station, wherein the equalized signals are modified, at the ground station, by: generating a plurality of code signals; injecting a code signal in each equalized signal, generating a code-embedded equalized signal; transmitting the code-embedded equalized signals to the non-terrestrial station; receiving the code-embedded equalized signals with the non-terrestrial station antenna; generating the plurality of the code signals at the non-terrestrial station; generating a channel representation for each code-embedded equalized signal, by correlating the code-embedded equalized digital signals with the plurality of the code signals generated at the non-terrestrial station; estimating channel parameters using the channel representation; updating the equalizers, such that when updated equalizers are applied to the uplink data stream, the transmitted equalized signals arrive at the non-terrestrial station in phase; transmitting the equalized signals to the non-terrestrial station; and receiving the equalized signals with the antenna of the non-terrestrial station.

Example 66: The non-transitory computer storage of Example 65, wherein the operations further comprise: transmitting a feedback signal, the feedback signal, comprising information on the received equalized signals.

Example 67: The non-transitory computer storage of some or all of Examples 65 and 66, wherein the operations further comprise: transmitting a feedback signal, the feedback signal, comprising the channel representation for each code-embedded equalized signal.

Example 68: The non-transitory computer storage of some or all of Examples 65-67, wherein the operations further comprise: generating a feedback signal, comprising information on the received equalized signals wherein the feedback signal is generated at one or more of the non-terrestrial station, at an original ground station, or at a ground station different than the ground station, receiving the uplink data stream.

Example 69: The non-transitory computer storage of some or all of Examples 65-68, wherein the operations further comprise: transmitting a feedback signal, comprising the channel representation for each code-embedded equalized signal; correlating the code signals with the uplink data stream, generating a cross-correlation; and estimating the channel parameters based on the channel representations and the cross-correlation received from correlating the code signals with the uplink data stream.

Example 70: The non-transitory computer storage of some or all of Examples 65-69, wherein the operations further comprise: transmitting a feedback signal, comprising the channel representation for each code-embedded equalized signal; correlating the code signals with the uplink data stream, generating a cross-correlation; and estimating the channel parameters based on the channel representations and the cross-correlation received from correlating the code signals with the uplink data stream, wherein estimating channel parameters comprises estimating one or more of gain, phase, equivalent filter coefficients, and delay values.

Example 71: The non-transitory computer storage of some or all of Examples 65-70, wherein the code-embedded equalized signals comprise digital signals, and the method further comprises: converting the code-embedded equalized signals to analog signals in the ground station and converting the code-embedded equalized signals to digital signals at the non-terrestrial station.

Example 72: The non-transitory computer storage of some or all of Examples 65-71, wherein the equalizers are finite impulse response (FIR) equalizers and applying the equalizers comprises applying equalizer coefficients to the uplink data stream.

Example 73: The non-transitory computer storage of some or all of Examples 65-72, wherein a plurality of antennas transmit the equalized signals, and the antennas use a non-penetrating method of mounting on a surface.

Example 74: The non-transitory computer storage of some or all of Examples 65-73, wherein a plurality of antennas placed in arbitrary locations, relative to one another, transmit the code-embedded equalized signals.

Example 75: The non-transitory computer storage of some or all of Examples 65-74, wherein a plurality of antennas transmit the equalized signals, and wherein the antennas are installed on the ground, on rooftops, and/or on sides of buildings in a deployment area.

Example 76: The non-transitory computer storage of some or all of Examples 65-75, wherein a plurality of antennas transmit the equalized signals, and wherein the antennas are placed hundreds of wavelengths or more apart from each other.

Example 77: The non-transitory computer storage of some or all of Examples 65-76, wherein a plurality of antennas transmit the equalized signals, and wherein the antennas are pointed in a fixed direction during the operations.

Example 78: The non-transitory computer storage of some or all of Examples 65-77, wherein a plurality of antennas transmit the equalized signals, and wherein the antennas independently track the non-terrestrial station as it moves around in the sky.

Example 79: The non-transitory computer storage of some or all of Examples 65-78, wherein a plurality of antennas transmit the equalized signals, and wherein the antennas cooperatively track the non-terrestrial station as it moves around in the sky.

Example 80: The non-transitory computer storage of some or all of Examples 65-79, wherein the non-terrestrial station comprises a satellite, or a high-altitude balloon.

Example 81: The non-transitory computer storage of some or all of Examples 65-80, wherein the equalized signals are upconverted and amplified using components with a single wide operating band, or with components that cover several sub-bands.

Example 82: The non-transitory computer storage of some or all of Examples 65-81, wherein the ground station comprises a plurality of antennas for transmitting the equalized signals, each equalized signal having a corresponding transmission channel, linked with an antenna, wherein the equalized signals comprise digital signals, and the digital signals are converted into analog signals with dedicated circuitry corresponding to each antenna, or with circuitry shared between multiple antennas.

Example 83: The non-transitory computer storage of some or all of Examples 65-82, wherein the ground station comprises a plurality of antennas for transmitting the equalized signals, each equalized signal having a corresponding transmission channel, linked with an antenna, wherein the equalized signals comprise digital signals, and the digital signals are converted into analog signals with dedicated circuitry corresponding to each antenna, or with circuitry shared between multiple antennas, and wherein the analog signals are switched between multiple sets of circuitry after being converted from digital signals.

Example 84: A system comprising one or more processors, wherein the one or more processors are configured to perform operations comprising: receiving, at a ground station and from a modem coupled to a communication network, an uplink data stream, for transmission to a non-terrestrial station; initializing a plurality of equalizers, the number of equalizers corresponding to a number of transmission channels, selected for transmitting the uplink data stream to the non-terrestrial station; applying the plurality of the equalizers to the uplink data stream, each equalizer generating at least an equalized signal, wherein the equalized signals are modified such that the modified signals are distinct from each other when received at the non-terrestrial station, wherein the equalized signals are modified, at the ground station, by: generating a plurality of code signals; injecting a code signal in each equalized signal, generating a code-embedded equalized signal; transmitting the code-embedded equalized signals to the non-terrestrial station; receiving the code-embedded equalized signals with the non-terrestrial station antenna; generating the plurality of the code signals at the non-terrestrial station; generating a channel representation for each code-embedded equalized signal, by correlating the code-embedded equalized digital signals with the plurality of the code signals generated at the non-terrestrial station; estimating channel parameters using the channel representation; updating the equalizers, such that when updated equalizers are applied to the uplink data stream, the transmitted equalized signals arrive at the non-terrestrial station in phase; transmitting the equalized signals to the non-terrestrial station; and receiving the equalized signals with the antenna of the non-terrestrial station.

Example 85: The system of Example 84, wherein the operations further comprise: transmitting a feedback signal, the feedback signal, comprising information on the received equalized signals.

Example 86: The system of some or all of Examples 84 and 85, wherein the operations further comprise: transmitting a feedback signal, the feedback signal, comprising the channel representation for each code-embedded equalized signal.

Example 87: The system of some or all of Examples 84-86, wherein the operations further comprise: generating a feedback signal, comprising information on the received equalized signals wherein the feedback signal is generated at one or more of the non-terrestrial station, at an original ground station, or at a ground station different than the ground station, receiving the uplink data stream.

Example 88: The system of some or all of Examples 84-87, wherein the operations further comprise: transmitting a feedback signal, comprising the channel representation for each code-embedded equalized signal; correlating the code signals with the uplink data stream, generating a cross-correlation; and estimating the channel parameters based on the channel representations and the cross-correlation received from correlating the code signals with the uplink data stream.

Example 89: The system of some or all of Examples 84-88, wherein the operations further comprise: transmitting a feedback signal, comprising the channel representation for each code-embedded equalized signal; correlating the code signals with the uplink data stream, generating a cross-correlation; and estimating the channel parameters based on the channel representations and the cross-correlation received from correlating the code signals with the uplink data stream, wherein estimating channel parameters comprises estimating one or more of gain, phase, equivalent filter coefficients, and delay values.

Example 90: The system of some or all of Examples 84-89, wherein the code-embedded equalized signals comprise digital signals, and the method further comprises: converting the code-embedded equalized signals to analog signals in the ground station and converting the code-embedded equalized signals to digital signals at the non-terrestrial station.

Example 91: The system of some or all of Examples 84-90, wherein the equalizers are finite impulse response (FIR) equalizers and applying the equalizers comprises applying equalizer coefficients to the uplink data stream.

Example 92: The system of some or all of Examples 84-91, wherein a plurality of antennas transmit the equalized signals, and the antennas use a non-penetrating method of mounting on a surface.

Example 93: The system of some or all of Examples 84-92, wherein a plurality of antennas placed in arbitrary locations, relative to one another, transmit the code-embedded equalized signals.

Example 94: The system of some or all of Examples 84-93, wherein a plurality of antennas transmit the equalized signals, and wherein the antennas are installed on the ground, on rooftops, and/or on sides of buildings in a deployment area.

Example 95: The system of some or all of Examples 84-94, wherein a plurality of antennas transmit the equalized signals, and wherein the antennas are placed hundreds of wavelengths or more apart from each other.

Example 96: The system of some or all of Examples 84-95, wherein a plurality of antennas transmit the equalized signals, and wherein the antennas are pointed in a fixed direction during the operations.

Example 97: The system of some or all of Examples 84-96, wherein a plurality of antennas transmit the equalized signals, and wherein the antennas independently track the non-terrestrial station as it moves around in the sky.

Example 98: The system of some or all of Examples 84-97, wherein a plurality of antennas transmit the equalized signals, and wherein the antennas cooperatively track the non-terrestrial station as it moves around in the sky.

Example 99: The system of some or all of Examples 84-98, wherein the non-terrestrial station comprises a satellite, or a high-altitude balloon.

Example 100: The system of some or all of Examples 84-99, wherein the equalized signals are upconverted and amplified using components with a single wide operating band, or with components that cover several sub-bands.

Example 101: The system of some or all of Examples 84-100, wherein the ground station comprises a plurality of antennas for transmitting the equalized signals, each equalized signal having a corresponding transmission channel, linked with an antenna, wherein the equalized signals comprise digital signals, and the digital signals are converted into analog signals with dedicated circuitry corresponding to each antenna, or with circuitry shared between multiple antennas.

Example 102: The system of some or all of Examples 84-101, wherein the ground station comprises a plurality of antennas for transmitting the equalized signals, each equalized signal having a corresponding transmission channel, linked with an antenna, wherein the equalized signals comprise digital signals, and the digital signals are converted into analog signals with dedicated circuitry corresponding to each antenna, or with circuitry shared between multiple antennas, and wherein the analog signals are switched between multiple sets of circuitry after being converted from digital signals.

Some portions of the preceding detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general-purpose computer selectively activated or reconfigured by a computer program stored in the computer. Such a computer program may be stored in a computer readable storage medium, such as, but not limited to, any type of disk including, hard drives, floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects.

What is claimed is:

1. A method of communication comprising:
receiving, by a plurality of antennas, radio waveforms from a non-terrestrial station, wherein the plurality of antennas comprise an arbitrary placement relative to one another, and not having a specified displacement between the plurality of the antennas;
converting, by the plurality of the antennas, the radio waveforms to a plurality of analog signals, each analog signal comprising an analog signal channel;
converting the analog signal channels, with a plurality of analog to digital converters, to a plurality of digital signals, each digital signal comprising a digital signal channel;
choosing a reference signal from the digital signals;
correlating the remaining plurality of the digital signals with the reference signal, wherein correlating comprises estimating equalization parameters for each digital signal, relative to the reference signal, wherein when equalization parameters are applied to each digital signal, the digital signals are equalized, relative to the reference signal, wherein estimating the equalization parameters are at least in part, based on data, received from the plurality of the analog to digital converters;
generating equalized signals by applying the equalization parameters to the digital signals, such that the equalized signals when combined, combine constructively;
generating a downlink data stream by combining the equalized signals;
providing the downlink data stream to a modem;
providing, by the modem, the downlink data stream to a communication network.

2. The method of claim 1, wherein the equalization parameters comprise one or more of gain, phase, and delay estimates for each digital signal, obtained from the output of each analog to digital converter.

3. The method of claim 1, wherein the equalization parameters comprise one or more of gain, phase, and delay estimates for each digital signal, obtained from the output of each analog to digital converter, and wherein the estimating of the gain, phase, and delay in a digital signal, relative to the reference signal, comprises:
initiating a correlator bank, with M phases;
offsetting each correlator in the bank by 1/M samples in time;
each correlator, calculating a correlation between a fractionally shifted digital signal with samples from the reference signal;
comparing peaks from each correlator;
selecting a correlator with the largest peak magnitude for estimating a delay between the digital signal and the reference signal;
offsetting a fractional delay of the selected correlator by an integer lag of the selected largest peak;
determining total lag comprising an integer lag from the correlator bank plus a ratio of an index of the correlator with the largest peak over M; and
estimating the gain and phase of the digital signal, relative to the reference signal, based at least in part on a complex coefficient of the largest peak.

4. The method of claim 1, wherein the reference signal comprises the digital signal having the largest magnitude of the digital signals.

5. The method of claim 1, wherein the data, received from the plurality of the analog to digital converters comprise an “in-phase,” and “quadrature” signal data (I/Q data) from the output of each analog to digital converter.

6. The method of claim 1, wherein estimating equalization parameters further comprises estimating channels obtained from a least-squares estimator.

7. The method of claim 1, wherein the antennas are placed hundreds of wavelengths or more apart from each other.

8. The method of claim 1, wherein the antennas independently track the non-terrestrial station as it moves around in the sky.

9. The method of claim 1, wherein the antennas cooperatively track the non-terrestrial station as it moves in the sky.

10. The method of claim 1, wherein the non-terrestrial station comprises one or more satellites, and/or high-altitude balloons.

11. The method of claim 1, wherein the plurality of analog signals is amplified and down converted using components with a single wide operating band.

12. The method of claim 1, wherein the plurality of analog signals is amplified and down converted using components that cover several sub-bands.

13. The method of claim 1, wherein the plurality of analog signals is converted into a plurality of digital signals before choosing a reference signal and wherein the analog signals from each antenna element are converted into digital signals with circuitry dedicated to that antenna element.

14. The method of claim 1, wherein the plurality of analog signals is converted into a plurality of digital signals before choosing a reference signal and wherein the analog signals from each antenna element are converted into digital signals with circuitry shared between multiple antenna elements.

15. The method of claim 1, wherein the plurality of analog signals is converted into a plurality of digital signals before choosing a reference signal, wherein the analog signals from each antenna are converted into digital signals with circuitry shared between the plurality of the antennas, and wherein the analog signals are switched between multiple sets of circuitry before being converted into digital signals.

16. A non-transitory computer storage that stores executable program instructions that, when executed by one or more computing devices, configure the one or more computing devices to perform operations comprising:
receiving, by a plurality of antennas, radio waveforms from a non-terrestrial station, wherein the plurality of antennas comprise an arbitrary placement relative to one another, and not having a specified displacement between the plurality of the antennas;
converting, by the plurality of the antennas, the radio waveforms to a plurality of analog signals, each analog signal comprising an analog signal channel;
converting the analog signal channels, with a plurality of analog to digital converters, to a plurality of digital signals, each digital signal comprising a digital signal channel;
choosing a reference signal from the digital signals;
correlating the remaining plurality of the digital signals with the reference signal, wherein correlating comprises estimating equalization parameters for each digital signal, relative to the reference signal, wherein when equalization parameters are applied to each digital signal, the digital signals are equalized, relative to the reference signal, wherein estimating the equalization parameters are at least in part, based on data, received from the plurality of the analog to digital converters;
generating equalized signals by applying the equalization parameters to the digital signals, such that the equalized signals when combined, combine constructively;
generating a downlink data stream by combining the equalized signals;
providing the downlink data stream to a modem; and
providing, by the modem, the downlink data stream to a communication network.

17. The non-transitory computer storage of claim 16, wherein the equalization parameters comprise one or more of gain, phase, and delay estimates for each digital signal, obtained from the output of each analog to digital converter.

18. The non-transitory computer storage of claim 16, wherein the equalization parameters comprise one or more of gain, phase, and delay estimates for each digital signal, obtained from the output of each analog to digital converter, and wherein the estimating of the gain, phase, and delay in a digital signal, relative to the reference signal, comprises:
initiating a correlator bank, with M phases;
offsetting each correlator in the bank by 1/M samples in time;
each correlator, calculating a correlation between a fractionally shifted digital signal with samples from the reference signal;
comparing peaks from each correlator;
selecting a correlator with the largest peak magnitude for estimating a delay between the digital signal and the reference signal;
offsetting a fractional delay of the selected correlator by an integer lag of the selected largest peak;
determining total lag comprising an integer lag from the correlator bank plus a ratio of an index of the correlator with the largest peak over M; and
estimating the gain and phase of the digital signal, relative to the reference signal, based at least in part on a complex coefficient of the largest peak.

19. The non-transitory computer storage of claim 16, wherein the reference signal comprises the digital signal having the largest magnitude of the digital signals.

20. The non-transitory computer storage of claim 16, wherein the data, received from the plurality of the analog to digital converters comprise an “in-phase,” and “quadrature” signal data (I/Q data) from the output of each analog to digital converter.
